(19) United States
(12) Patent Application Publication
(10) Pub. No.: US 2008/0217368 A1
(43) Pub. Date: Sep. 11, 2008

(54) HANDS-FREE LOAD CARRYING APPARATUS

(76) Inventor: Melvin John Denton, Trenton, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/683,660

(22) Filed: Mar. 8, 2007

(51) Int. Cl. A61G 1/00; A45F 5/00

(52) U.S. Cl. 224/159; 224/101; 224/268

(57) ABSTRACT

An improved carrying apparatus that utilizes mechanical principles to transfer a load from in front of a user over the shoulder of a user, down the back and around the torso of a user, to the stomach area where a portion of the load is supported by the stomach muscles of the user. The apparatus may include a load attachment member configured to be positioned in front of a user.

### BACKGROUND

a. Technical Field

The invention relates generally to a hands-free load carrying apparatus, including a hands-free load carrying apparatus that transfers a portion of a vertical load from in front of a user through a load transfer device to a horizontal force component directed toward the stomach of a user.

b. Description of Related Art

Various types of carrying apparatus exist to hold, support, and carry equipment or objects, such as a baby carrier. Such apparatus generally require the use of a stabilizing belt, so that the load is supported by the hips of a user of the apparatus. Alternatively, carrying apparatus are designed for the shoulders and/or upper back to bear the brunt of the load. However, carrying apparatus with loads supported by the hips, shoulders, or back may cause discomfort or strain to a user of the carrying apparatus.

Accordingly, there remains a need for a hands-free load carrying apparatus that minimizes and/or eliminates these deficiencies in the prior art.

### SUMMARY

The invention provides a load carrying apparatus. The load carrying apparatus may include a load attachment member including a rigid portion configured to be positioned in front of a user. The load carrying apparatus may further include a first frame member extending from the load attachment member and configured to be positioned over a shoulder of the user. The load carrying apparatus may further include a second frame member extending from the second frame member and including a rigid portion that extends from the back of the user to the front of the user. The load carrying apparatus may further include a front support member coupled to the second frame member, such that the front support member supports a portion of a vertical load attached to the load attachment member.

The invention further provides a method of carrying a load. The method of carrying a load may include the step of attaching a load to a load attachment member including a rigid portion positioned in front of a person carrying the load. The method may further include the steps of transferring the load through a first frame member configured to be positioned over a shoulder of the user and further transferring the load through a second frame member to a front support member positioned in front of the person carrying the load. The method may further include the step of supporting at least a portion of the load with the stomach muscles of the person carrying the load.

The invention solves the problems and overcomes the deficiencies of the prior hands-free load carrying apparatus. The improved carrying apparatus is advantageous as compared to conventional carrying apparatus. First, the inventive carrying apparatus utilizes mechanical principles to transfer at least a portion of a load from in front of a user of the apparatus through a pivot point located at a shoulder of a user, down the back and around the torso of a user, to the stomach area where the transferred load is supported by the stomach muscles of the user, rather than the hips, shoulders, or back of the user. Second, the inventive carrying apparatus enables a user to lift and/or carry bulky, heavy, or awkward items without the use of a user's hands. Third, the inventive carrying apparatus may be used for holding and supporting a baby carrier, a musical instrument, or camera or other movie equipment. In addition, the inventive carrying apparatus may be used for various tasks for farm or migrant work such as planting or picking, construction work, maintenance tasks, military uses, and various other instances where a load has to be carried and hands need to be free to be utilized. Fourth, the inventive carrying apparatus may be used therapeutically to alleviate back pain since the load is supported by a user's stomach muscles, rather than the back muscles.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the detailed description serve to explain the principles of the invention. In the drawings:

FIG. 1 is a front view of a user of a carrying apparatus in accordance with an embodiment of the invention.

FIG. 2 is a perspective view of a carrying apparatus in accordance an embodiment of the invention.

FIG. 3 is a front view of a front support member of the carrying apparatus of FIG. 2.

FIG. 4 is a side view of a front support member of the carrying apparatus of FIG. 2.

FIG. 5 is a front view of a carrying apparatus with an exemplary load attachment member in accordance with another embodiment of the invention.

FIGS. 6A-6D are a front view of the ends of the load attachment member and frame of the carrying apparatus of FIG. 5.

FIGS. 7A-7F are a front view of a series of load attachment members for the carrying apparatus of FIG. 5.

### DETAILED DESCRIPTION OF THE PREFERRED EMBODIMENT

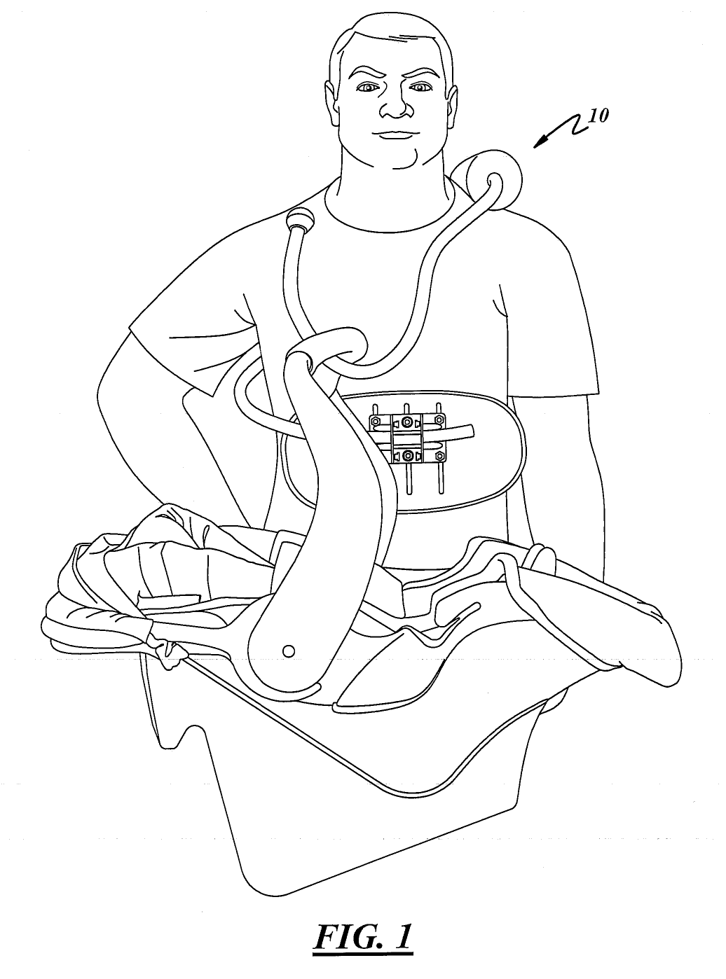

Referring now to the drawings wherein like reference numerals designate corresponding parts throughout the several views, FIGS. 1-5 illustrate a hands-free load carrying apparatus in accordance with embodiments of the invention. The inventive carrying apparatus 10 may include a load attachment member 12, a first frame member 14, a second frame member 18, and a front support member 20. FIG. 1 depicts a user of a carrying apparatus in accordance with an embodiment of the invention.

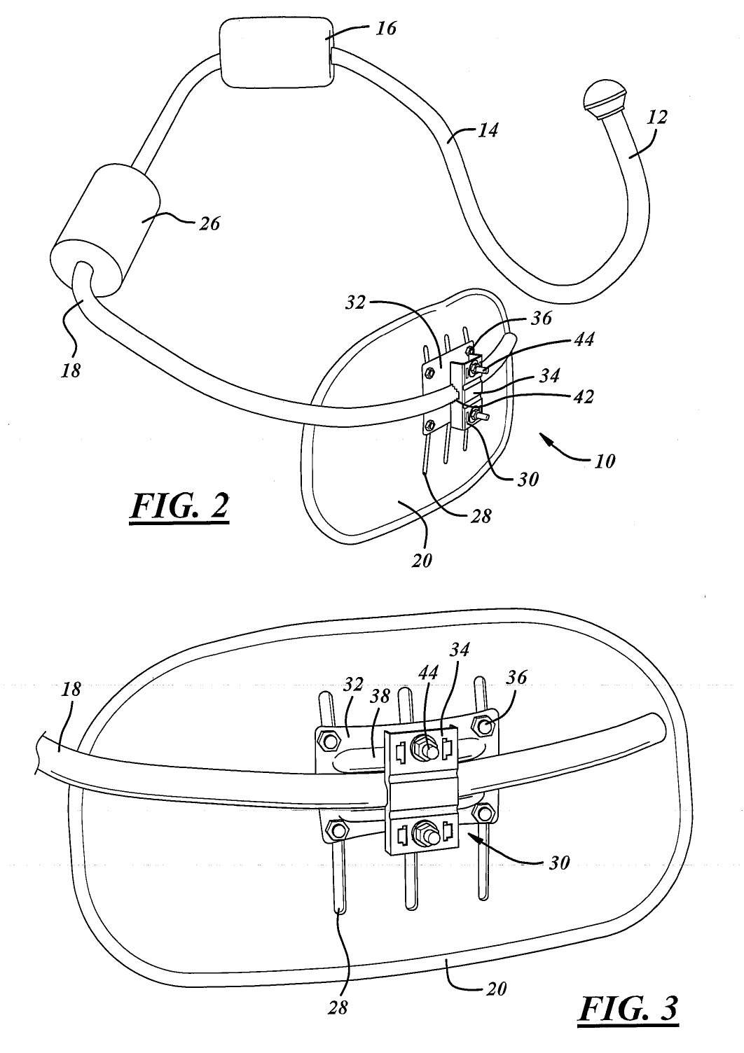

Referring now to FIG. 2, load attachment member 12 is provided for securing a load to carrying apparatus 10. Load attachment member 12 may be configured to be disposed in front of a person using carrying apparatus 10. Load attachment member 12 may be comprise a rigid position that is configured to be disposed in front of a person using carrying apparatus 10. In an exemplary embodiment, load attachment member 12 may comprise a curved member, such as the hook as shown in FIGS. 1-2. In another exemplary embodiment, load attachment member 12 may also comprise all s-hook as shown in FIG. 5. In other exemplary embodiments, load attachment member 12 may comprise a spring, a c-hook, a button, a dead-end, or a D-ring as shown in FIGS. 7A-7F. In other exemplary embodiments, load attachment member 12 may also comprise all o-ring, a d-ring, a sling, a strap, a rope, a cable, scissors, a clamp, or a combination thereof. Although these load attachments members are mentioned in detail, it is understood by those of ordinary skill in the art that various other load attachment members may be utilized and remain within the spirit and scope of the invention.

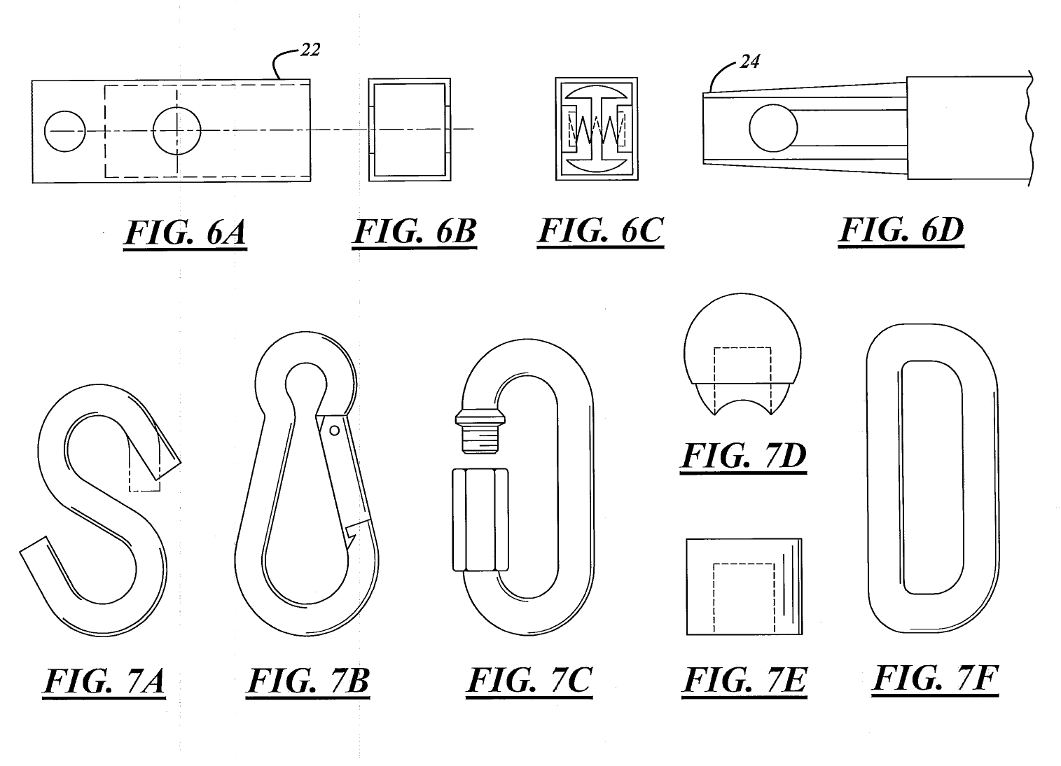

Referring again to FIGS. 1-2, in an exemplary embodiment, load attachment member 12 may be integral with first frame member 14. Referring again to FIG. 5, in another exemplary embodiment, load attachment member 12 may be removably coupled to first frame member 14. For example, referring now to FIGS. 5 and 6, in one exemplary embodiment, load attachment member 12 may comprise a female end 22, and first frame member 14 may comprise a complementary male end 24 for coupling load attachment member 12 and first frame member 14. In another exemplary embodiment, load attachment member 12 may comprise a male end, and first frame member 14 may comprise a complementary female end for coupling load attachment member 12 and first frame member 14. Through use of complementary male and female ends 22, 24, any of the various types of load attachment members described herein may be interchangeable on first frame member 14. Female end 22 and male end 24 may comprise molded plastic. Although molded plastic is described in detail, it is understood by those of ordinary skill in the art that various other materials may be used and remain within the spirit and scope of the invention. A fastener, such as a securing pin, may also be used in an exemplary embodiment to removably couple load attachment member 12 to first frame member 14.

Referring again to FIGS. 1-4, first frame member 14 may be provided to transfer the load from the load attachment member 12. First frame member 14 extends from load attachment member 12 toward a shoulder of a person using carrying apparatus 10. First frame member 14 may comprise a hollow, cylindrical, metal tube in an exemplary embodiment. An exemplary metal for the tube may comprise steel or aluminum. Although a hollow, cylindrical, metal tube is mentioned in detail, it is understood by those of ordinary skill in the art that various other types of materials and configurations may be used and remain within the spirit and scope of the invention. For example, in another exemplary embodiment, the first frame member 14 may comprise molded plastic. In another exemplary embodiment, the first frame member 14 may be solid. In another exemplary embodiment, the first frame member 14 may be round, oval, rectangular, triangular, or elliptical in circumference or outer perimeter. In another exemplary embodiment, first frame member 14 may be configured to extend or contract at one or more points in order to provide for adjustment of first frame member 14 to accommodate variations in physical differences and body sizes and shapes.

First frame member 14 may be configured to be positioned over a shoulder of a user at a load transfer point 16. Load transfer point 16 may be provided as a pivot point to transfer load from the front of a person using carrying apparatus 10 down the back and around the torso to the stomach area. Load transfer point 16 may include a pad for minimizing discomfort at the load transfer point 16. The pad may be generally rectangular in shape and comprise foam. Although a rectangular shape and foam are mentioned in detail, it is understood by those of ordinary skill in the art that various other shapes and materials may be used to alleviate or minimize discomfort at the load transfer point 16 and remain within the spirit and scope of the invention.

Second frame member 18 may be provided to further transfer load from first frame member 14. Second frame member 18 may extend from first frame member 14. Second frame member 18 may include a rigid portion that extends from the back and around a torso of a person using carrying apparatus 10 to a front of a person using carrying apparatus 10. In an exemplary embodiment, second frame member 18 extends down the back of a user of carrying apparatus 10 at a first angle and then continues down at a second angle and then continues around the torso and horizontally to a stomach area of a user of carrying apparatus 10. In an exemplary embodiment, second frame member 18 extends around a torso of the user under all opposite shoulder than the shoulder over which first frame member 14 is configured to be positioned. Second frame member 18 may comprise a hollow, cylindrical, metal tube in an exemplary embodiment. An exemplary metal for the tube may comprise steel or aluminum. Although a hollow, cylindrical, metal tube is mentioned in detail, it is understood by those of ordinary skill in the art that various other types of materials and configurations may be used and remain within the spirit and scope of the invention. For example, in another exemplary embodiment, the second frame member 18 may comprise molded plastic. In another exemplary embodiment, the second frame member 18 may be solid. In another exemplary embodiment, the second frame member 18 may be round, oval, rectangular, triangular, or elliptical in circumference or outer perimeter. In another exemplary embodiment, second frame member 18 maybe configured to extend or contract at one or more points in order to provide for adjustment of second frame member 18 to accommodate variations in physical differences and body sizes and shapes. Second frame member 18 may be integral with first frame member 14 as shown in FIG. 1. However, it is understood by those of ordinary skill in the art that second frame member 18 may be separate from first frame member 14 and remain within the spirit and scope of the invention.

In an exemplary embodiment, a pad 26 may be disposed on second frame member 18 toward the back of a user of carrying apparatus 10 for improving comfort. Pad 26 may be generally rectangular in shape and comprise foam. Although a rectangular shape and foam are mentioned in detail, it is understood by those of ordinary skill in the art that various other shapes and materials may be used for pad 26 to provide for a comfortable fit. In another exemplary embodiment, one or more additional pads may be disposed on carrying apparatus 10 for minimizing discomfort. It is understood by those of ordinary skill in the art that one or more pads may be disposed on carrying apparatus 10 at various locations to minimize discomfort, and the carrying apparatus would remain within the spirit and scope of the invention.

Front support member 20 may be provided to support at least a portion of the load that is transferred from the load attachment member 12. Front support member 20 may be coupled to second frame member 18. Front support member 20 may support a portion of a vertical load that is attached to load attachment member 12 because of the transfer of at least a portion of the vertical load to a horizontal component of a force that is received by front support member 20. Front support member 20 may comprise a pad as shown in FIG. 1. However, it is understood by those of ordinary skill in the art that front support member 20 may comprise any weight distribution member, such as, but not limited to, an expanded bar, and remain within the spirit and scope of the invention. Front support member 20 may be generally oval in shape. Although an oval shape is mentioned in detail, it is understood by those of ordinary skill in the art that various other shapes may be used for front support member 20 and remain within the spirit and scope of the invention. Front support member 20 may comprise a thin pad of molded plastic with a raised ribbon of plastic material around the perimeter for added rigidity and support. Although a molded plastic pad with a raised ribbon of plastic material around the perimeter of front support member 20 is mentioned in detail, it is understood by those of ordinary skill in the art that various other materials may be used for front support member 20 and remain within the spirit and scope of the invention. Front support member 20 may include a plurality of vertically oriented slots 28 Slots 28 may be molded into front support member 20. Slots 28 are provided for vertical adjustment of front support member 20 to ensure that front support member 20 is located in the center of the stomach area just below the lib cage of a user of carrying apparatus 10 for the most comfortable fit.

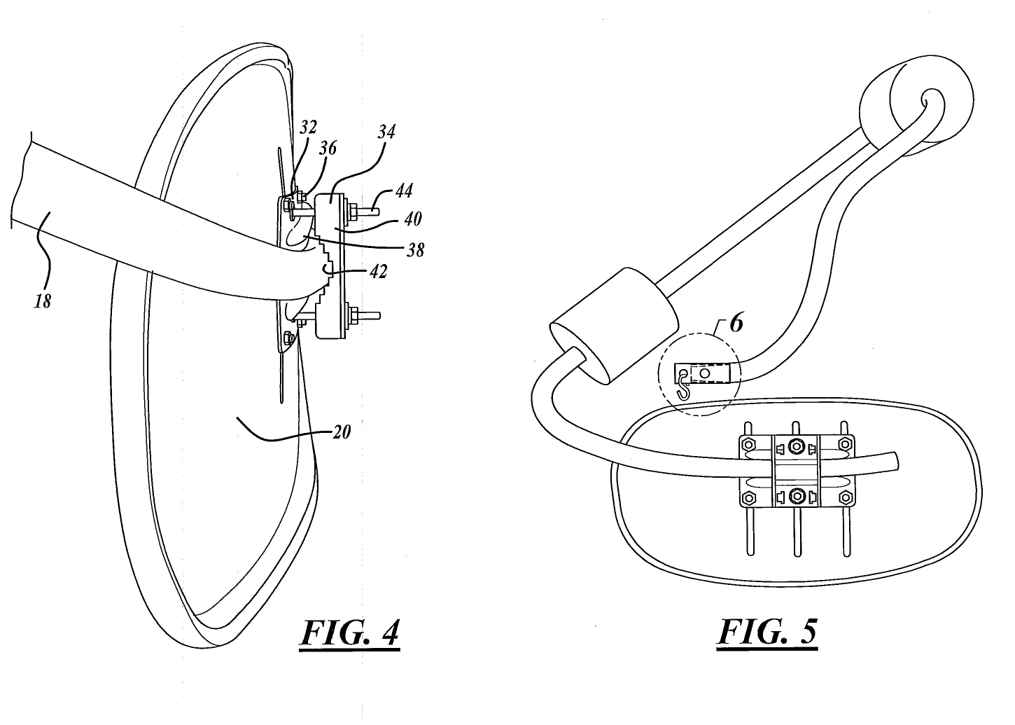

In all embodiment, an adjustable clamp 30 may be provided to couple front support member 20 to second frame member 18. Adjustable clamp 30 may, for example, comprise a first plate 32 and a second plate 34. First plate 32 is provided for attachment to front support member 20 and is configured to receive second flame member 18. First plate 32 is generally rectangular in shape. Although a rectangular shape is mentioned in detail, it is understood by those of ordinary skill in the art that various other shapes may be utilized and remain within the spirit and scope of the invention. First plate 32 may comprise a metal, such as steel or aluminum. Although metal is mentioned in detail, it is understood by those of ordinary skill in the art that various other materials may be utilized and remain within the spirit and scope of the invention. First plate 32 may be fastened to front support member 20 by fasteners 36. Fasteners 36 may comprise screws or any other type of fasteners that are conventional in the art. First plate 32 may include scalloped ridges 38, as best viewed in FIGS. 3-4, that are configured to hold and receive second frame member 18.

Second plate 34 may be provided to secure front support member 20 to second frame member 18. Second plate 34 may be generally flat and rectangular in shape with two panels 40 extending transverse to second plate 34. Although a flat, rectangular shape is mentioned in detail, it is understood by those of ordinary skill in the art that various other shapes may be utilized and remain within the spirit and scope of the invention. Second plate 34 may comprise a metal, such as steel or aluminum. Although metal is mentioned in detail, it is understood by those of ordinary skill in the art that various other materials may be utilized and remain within the spirit and scope of the invention. Panels 40 may each include a stepped cut-out 42 proximate a center of panels 40. Cut-out 42 may be configured to receive second frame member 18. Panels 40 of second plate 34 may extend toward first plate 32 when second plate 34 is placed over second frame member 18 to secure front support member 20 to second frame member 18. Second plate 34 may be fastened to first plate 32 by fasteners 44. Fasteners 44 may comprise nuts and bolts or any other type of fasteners that are conventional in the art.

The inventive carrying apparatus is advantageous as compared to conventional carrying apparatus. First, the inventive carrying apparatus utilizes mechanical principles to transfer at least a position of a load from in front of a user of the apparatus through a pivot point located at a shoulder of a user, down the back and around the torso of a user, to the stomach area where the transferred load is supported by the stomach muscles of the user. Second, the inventive carrying apparatus enables a user to lift and/or carry bulky, heavy, or awkward items without the use of a user's hands. Third, the inventive carrying apparatus may be used for holding and supporting a baby carrier, a musical instrument, or camera or other movie equipment. In addition, the inventive carrying apparatus may be used for various tasks for farm or migrant work planting or picking, construction work, maintenance tasks, military uses, and various other instances where a load has to be carried and hands utilized. Fourth, the inventive carrying apparatus may be used therapeutically to alleviate back pain since the load is supported by a user's stomach muscles, rather than the back muscles.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

1. A load carrying apparatus, comprising:
a load attachment member including a rigid portion configured to be positioned in front of a user;
a first frame member extending from said load attachment member and configured to be positioned over a shoulder of the user;
a second frame member extending from said first frame member and including a rigid portion that extends from the back of the user to the front of the user; and
a front support member coupled to said second frame member, such that the front support member supports a portion of a vertical load attached to said load attachment member.

2. A load carrying apparatus in accordance with claim 1, wherein said front support member comprises a pad.

3. A load carrying apparatus in accordance with claim 1, wherein said portion of said vertical load is transferred to a horizontal component of a force and said front support member is configured to receive said horizontal component of said force.

4. A load carrying apparatus in accordance with claim 1, wherein said second frame member extends from a shoulder down a back of the user.

5. A load carrying apparatus in accordance with claim 1, wherein said second frame member extends around a torso of the user to a front of the user.

6. A load carrying apparatus in accordance with claim 1, wherein said second frame member extends around a torso of the user under an opposite shoulder than the shoulder over which said first frame member is configured to be positioned.

7. A load carrying apparatus in accordance with claim 1, wherein said load attachment member comprises a hook.

8. A load carrying apparatus in accordance with claim 1, wherein said load attachment member comprises one of an s-hook, a spring, a c-hook, a button, a dead-end, and a D-ring.

9. A load carrying apparatus in accordance with claim 1, wherein said load attachment member is removably coupled to said first frame member.

10. A load carrying apparatus in accordance with claim 9, wherein one end of said load attachment member comprises a female end and one end of said first frame member comprises a complementary male end for removably coupling said load attachment member to said first frame member.

11. A load carrying apparatus in accordance with claim 9, wherein one end of said load attachment member comprises a male end and one end of said first frame member comprises a complementary female end for removably coupling said load attachment member to said first frame member.

12. A load carrying apparatus in accordance with claim 1, wherein said first frame member and said second frame member are solid.

13. A load carrying apparatus in accordance with claim 1, wherein said first frame member and said second frame member are hollow.

14. A load carrying apparatus in accordance with claim 1, wherein the length of said first frame member is adjustable by extending or contracting the length of said first frame member.

15. A load carrying apparatus in accordance with claim 1, wherein the length of said second frame member is adjustable by extending or contracting the length of said second frame member.

16. A load carrying apparatus in accordance with claim 1, wherein said front support member includes a plurality of slots for vertical adjustment of said front support member.

17. A load carrying apparatus in accordance with claim 1, wherein said front support member is coupled to said second frame member with a clamp.

18. A load carrying apparatus in accordance with claim 1, wherein a first pad is disposed on said first frame member at a position over a shoulder of the user.

19. A load carrying apparatus in accordance with claim 18, wherein a second pad is disposed at a preselected location along said second frame member.

20. A method of carrying a load, comprising the following steps:
attaching said load to a load attachment member including a rigid portion positioned in front of a person carrying said load;
transferring said load through a first frame member configured to be positioned over a shoulder of the user;
further transferring said load through a second frame member to a front support member positioned in front of the person carrying said load; and
supporting at least a portion of said load with the stomach muscles of the person carrying said load.

21. An apparatus for carrying a baby carrier, comprising:
a load attachment member including a rigid portion configured to be positioned in front of a user;
a first frame member extending from said load attachment member and configured to be positioned over the shoulder of the user;
a second frame member extending from said first frame member and including a rigid portion that extends from the back of the user to the front of the user; and
a front support member coupled to said second frame member such that the front support member supports at least a portion of the load of the baby carrier attached to said load attachment member.
